(19) United States
(12) Patent Application Publication
(10) Pub. No.: US 2005/0275287 A1
(43) Pub. Date: Dec. 15, 2005

(54) Snow and debris deflector for a track system

(76) Inventor: Remi Breton, St-Charles-de-Drummond (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 11/142,414

(22) Filed: Jun. 2, 2005

(30) Foreign Application Priority Data
Jun. 9, 2004 (CA) 2,470,548
Sep. 17, 2004 (CA) 2,482,036

(51) Int. Cl. B62D 25/16

(52) U.S. Cl. 305/107

(57) ABSTRACT

This invention relates to a deflector reducing debris, snow and soft soil ingestion in a sprocket or idler area of a vehicle equipped with tracks. The deflector comprises a rigid plate associated with this vehicle and a resilient pad which has an upper part customized to be in the conjunction with the rigid plate and a lower part freely extended from the upper part to limit the ingestion of debris in a sprocket or idler area in a driving condition of the vehicle. The resilient pad preferably has a plurality of longitudinal reinforcing elements which are projected from at least one of its surfaces.

### FIELD OF THE INVENTION

The present invention relates to track type vehicles, such as, but not limited to a construction vehicle or a military vehicle, and more specifically to a snow, ice, gravel, soil and debris deflector for a track system that reduces the amount of such snow, ice, gravel, soil and debris ingestion in the sprocket or idler area of the vehicles during driving operation.

### BACKGROUND OF THE INVENTION

Conventionally, a military vehicle comprises a set of 5 or 6 wheels on each side of the vehicle over which a track runs. The suspension of the wheels is independent. The system also comprises a sprocket and an idler, at each end of the vehicle that is above the ground. The way the track engages wheels to the sprocket and the idler makes it suitable for ingestion of soft soil, gravel, snow, ice or other debris. The small angle formed by the track will cause such substances to fall in and follow the track and then be ingested by the sprocket or the idler, especially when making small radius turn maneuvers. For example, a conventional front drive vehicle will ingest debris in the sprocket when turning in backward motion, and ingest debris in the idler when turning in forward motion.

This ingestion will typically create over-tension in the track system and eventually create failures especially when a rubber track is used. It could also make the track to touch the sponson and squeeze or damage components, or even force the track to fall off the wheels.

U.S. Pat. No. 4,763,961 issued to Parrot on Aug. 16, 1988 disclosed a debris removal apparatus which includes a hydraulically-operated pusher plate to push debris out of a tracking system and prevent debris' accumulation and packing. While this device may be suitable for the particular purpose to which it addresses, the design of this device is very complex.

Thus, there is a need to develop an effective snow and debris deflector for a track system without any complex mechanism.

### OBJECTS OF THE INVENTION

Accordingly, an object of the present invention is to provide a snow and debris deflector for a track system that obviates the above-mentioned disadvantages.

A further object of the present invention is to provide a snow and debris deflector for a track system that reduces the amount of snow, ice, gravel, soil or other debris ingestion in a sprocket or idler area of a vehicle equipped with tracks.

Another object of the present invention is to provide a snow, ice, gravel, soil and other debris deflector for a track system that keeps the track substantially free of same.

Still a further object of the present invention is to provide a snow, ice, gravel, soil and other debris deflector for a track system which is extremely simple in design and effective in operation.

Still another object of the present invention is to provide a snow, ice, gravel, soil and other debris deflector for a track system which prevents the track from falling off the wheels of the vehicle.

One more object of the present invention is to provide a snow, ice, gravel, soil and other debris deflector for a track system which allows continuity of cleaning action.

Yet another object of the present invention is to provide a deflector that will deflect snow, ice, gravel, soil and other debris while not causing any damage to the rubber track.

Another object of the present invention is to provide a snow, ice, gravel, soil and other debris deflector that can be easily repaired and renovated.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

### SUMMARY OF THE INVENTION

To attain these and other objects which will become more apparent as the description proceeds according to one aspect of the present invention, a snow, ice, gravel, soil and other debris deflector for a track system is provided.

The invention is characterized by a rubber reinforced pad, used in conjunction with a rigid steel plate. The main purpose of this invention is to limit the amount of snow, ice, gravel, soil and other debris ingestion in the track in the sprocket and idler area. This will reduce significantly the build up of material between the sprocket and the track or between the idler and the track. Reducing of the snow, ice, gravel, soil and other debris ingestion in the track in the sprocket and idler areas will considerably diminish the amount of tension created in the track and the system, and also will avoid the track to touch the sponson of the vehicle. This will prevent the track from falling off the wheels of the vehicle (this is sometimes referred to as de-tracking).

The deflector system according to the present invention consists of a rigid plate associated with the vehicle and positioned into a close proximity of a sprocket or idler, the rigid plate having a lower edge, a resilient pad having an upper part customized to be in conjunction with the rigid plate and a lower part freely extended from the upper part and at least partially protruded below the lower edge of the rigid plate to limit the snow, ice, gravel, soil and other debris ingestion in the sprocket or idler areas in a driving condition of the vehicle.

Preferably, the resilient pad has a plurality of vertical reinforcing elements which are projected from at least one surface of the resilient pad. At least one of the reinforcing elements may have a length different from any others. The reinforcing elements are preferably disposed within the resilient pad in a predetermined interval.

Preferably, the resilient pad is made from a molded composite material. The lower part of the resilient pad might have a shape generally matching that of the track system.

Preferably, at least part of the rigid plate is shaped as an arc following the sprocket or idler diameter. Preferably, the rigid plate is designed to avoid any interference with the inside of the track and is positioned with a space of around 0.5 inch to 1.5 inch from the sprocket or idler. Preferably, the lower edge of the rigid plate has a shape generally identical that of the lower part of the resilient pad.

Preferably, the conjunction of the resilient pad with the rigid plate is made in a manner to define a hinge-like point to allow the resilient pad to be solid in the direction of ingestion, but pivotable in other directions during the track system displacements.

Preferably, the resilient pad is rigid enough (in the ingestion direction) to stop, snow, ice, gravel, soil and other similar debris while being flexible enough to absorb high deflection without failure.

The invention accordingly comprises the further constructions, combination of elements, and arrangement of parts which will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1 is an isometric side view of a snow and debris deflector in a working position, according to the present invention;

FIG. 2 is a fragmentary isometric side view of a snow and debris deflector situated about a sprocket or idler;

FIG. 3 is an isometric front view of a snow and debris deflector according to the present invention shown removed from its mounting on the track assembly;

FIG. 4 is an isometric rear view of a snow and debris deflector according to the present invention shown a rigid plate and resilient pad in divided position; and

FIG. 5 is a side view of a snow and debris deflector according to the present invention shown removed from its mounting on the track assembly.

FIG. 6 is a side view of the snow and debris deflector shown in FIG. 1 when the vehicle is moving in direction F.

FIG. 7 is a side view of the snow and debris deflector shown in FIG. 1 when the vehicle is moving in direction R.

FIG. 8 is a side view of the snow and debris deflector shown in FIG. 1 when the vehicle is stopped.

### DETAILED DESCRIPTION OF THE PREFERRED EMBODIMENTS

A snow and debris deflector for a track system according to a preferred embodiment of the present invention is described hereinafter and illustrated in the appended figures.

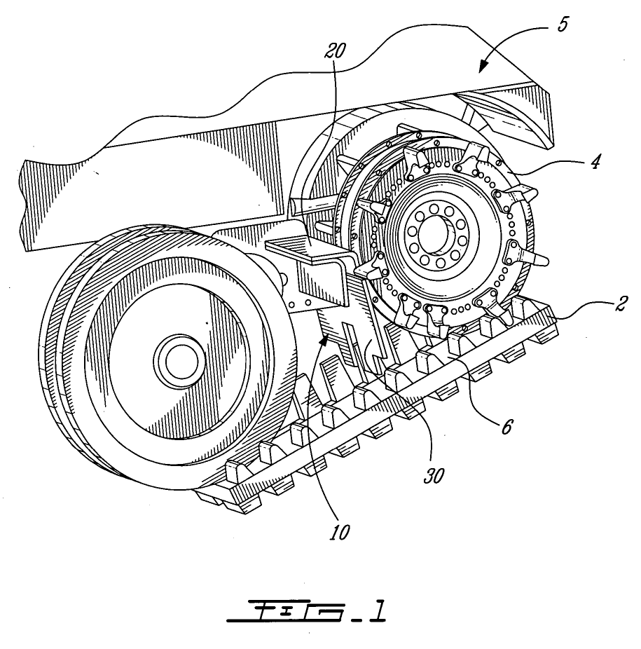

FIGS. 1 to 5 show a snow and debris deflector 10 for a track system that reduces the amount of snow, ice, gravel, soil and other debris ingestion (not shown) in a sprocket 4 or idler (not shown) area of a vehicle equipped with tracks 2.

The deflector 10 includes a rigid plate 20 and a resilient pad 30. The rigid plate 20 is associated with the vehicle 5 and is positioned into a close proximity of the sprocket 4 or idler (not shown) As seen in FIGS. 1, 3 and 5 the resilient pad 30 overlaps the rigid plate 20, its upper part 32 being attached to the rigid plate 20 and its lower part 34 freely extending from the upper part 32 below a lower edge 22 of the rigid plate 20 to limit the snow, ice, gravel, soil and other debris ingestion when the vehicle is in driving condition.

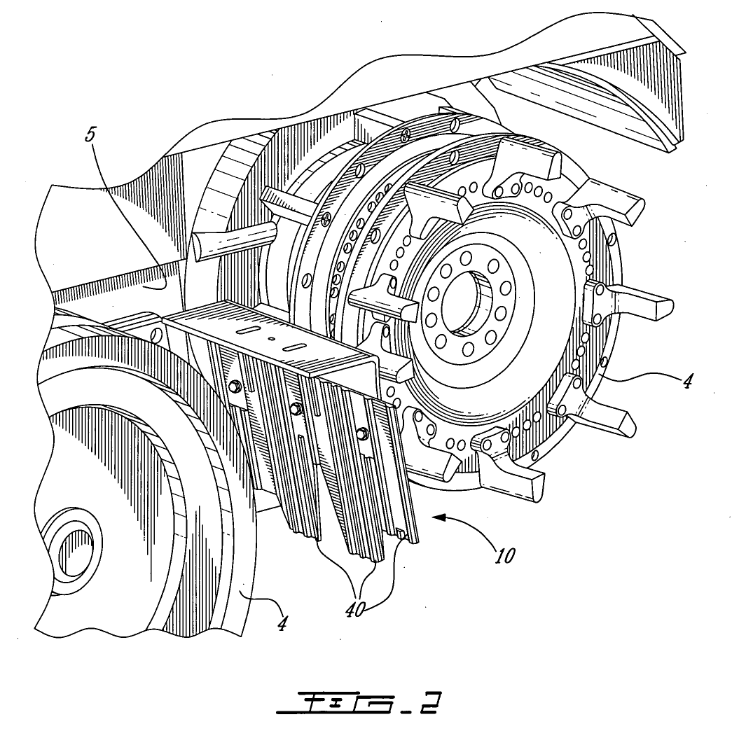

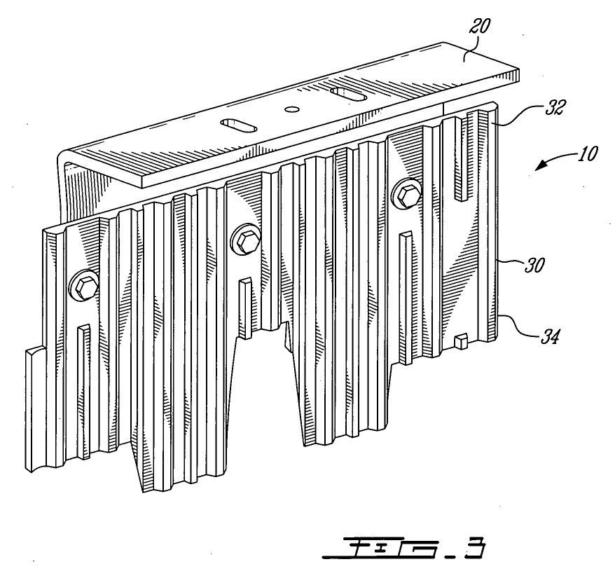

The resilient pad 30 has a plurality of vertical reinforcing elements 40 which are projected from at least one surface of said resilient pad 30. At least one of said reinforcing elements 40 has a length different from any others, as is illustrated in FIGS. 2 and 3. These reinforcing elements 40 are disposed within resilient pad 30 in a predetermined interval. It is preferable that the resilient pad 30 is made for example from a molded composite material.

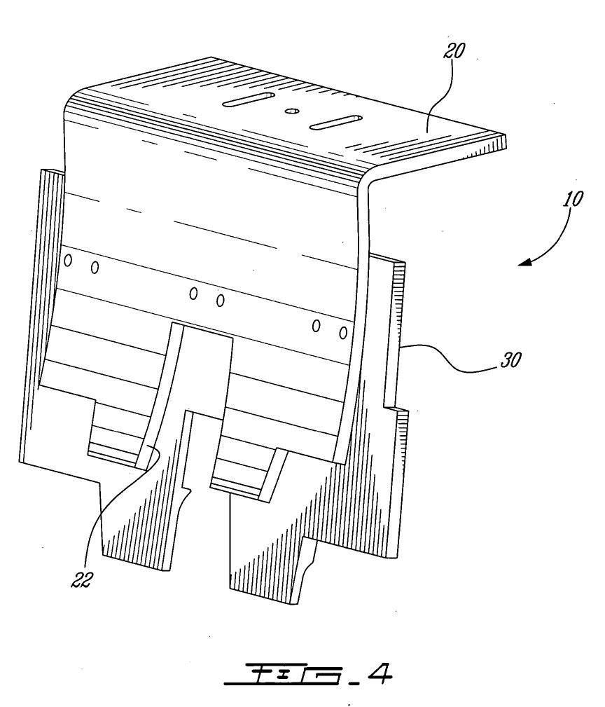

Referring to FIGS. 1 to 4, the lower part 34 of the resilient pad 30 has a shape which generally matches that of the profile of the inside 6 of the track 2. At least part of the rigid plate 20 is shaped as an arc (see FIGS. 4 and 5). This arc shape preferably follows the sprocket 4 or idler diameters. The rigid plate 20 is designed to avoid any interference with the inside 6 of the track 2 and is positioned with a small distance (around 0.5 inch to 1.5 inch or 12.5 mm to 37.5 mm in the case of a military vehicle) from the sprocket 4 or idler periphery. Preferably, the lower edge 22 of the rigid plate 20 also has a shape generally similar to that of the lower part 34 of the resilient pad 30.

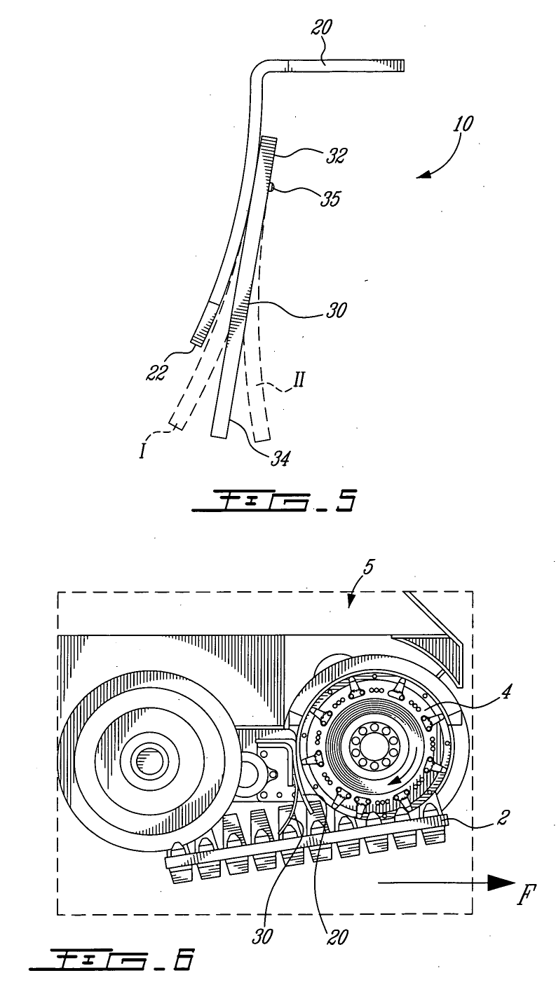

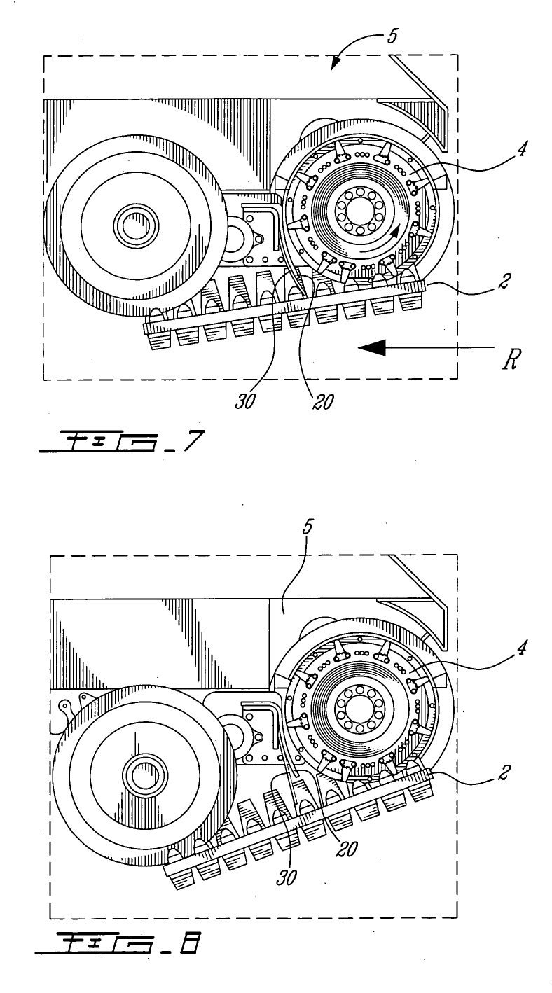

As shown in FIG. 5 the conjunction of the resilient pad 30 with the rigid plate 20 is assembled in a manner which allows to define a hinge-like point 35 to permit the resilient pad 30 to be solid in the direction of ingestion (position I which correspond to FIG. 7), but pivotable in other directions (position II which corresponds to FIG. 6) during the track system displacements. It is preferable that the rigid plate 20 is made from steel or other similar rigid material.

Tracked vehicles are very often provided with suspensions. As a result, when the vehicle runs over uneven terrain, the track may move upwardly or downwardly and become in contact with the resilient pad 30. The pad 30 may then be subject to severe bending as shown in FIGS. 6 and 7, especially when the track is displaced towards the sprocket as shown in FIG. 7.

The rigid plate 20 must be fixed to the vehicle such that its lower edge 22 never come in to direct contact with the interior 6 of the track 2 whether the suspension is extended or compressed to its maximum.

As is well understood, these reinforcing elements 40 may assume a variety of forms, lengths and cross-sectional profiles (not shown). Also, these reinforcing elements 40 may be made from any suitable material well known in the art.

Using the snow and debris deflector 10 for a track system according to the present invention allows an effective track system protection without any complex and expensive mechanisms.

The drawings and the description attached to it are only intended to illustrate the idea of the invention. As to the details, the invention may vary within the scope of the claims. So, the shape reinforcing elements 40 may be formed as desired, considering the needs and the specifics of the vehicle.

Although the present snow and debris deflector 10 for a track system has been described with a certain degree of particularity, it is to be understood that the disclosure has been made by way of example only and that the present invention is not limited to the features of the embodiment(s) described and illustrated herein, but includes all variations and modifications within the scope and spirit of the invention as hereinafter claimed.

1. A snow and debris deflector for a track system that reduces the amount of snow, ice, gravel, soil and other debris ingestion in a sprocket area or idler area of a vehicle equipped with rubber tracks, said deflector comprising:
a rigid plate being associated with said vehicle and positioned into a close proximity of said sprocket or idler, said rigid plate having a lower edge,
a resilient pad having an upper part customized to be in conjunction with said rigid plate and a lower part freely extended from the upper part and at least partially protruded below said lower edge of the rigid plate to limit the ingestion of said snow, ice, gravel, soil or other debris in a sprocket or idler area in a driving condition of the vehicle.

2. A deflector according to claim 1, wherein said resilient pad has a plurality of vertical reinforcing elements which are projected from at least one surface of said resilient pad.

3. A deflector according to claim 2, wherein at least one of said reinforcing elements has a length different from any others.

4. A deflector according to claim 2 or 3, wherein said reinforcing elements are disposed within said resilient pad in a predetermined interval.

5. A deflector according to any one of claims 1 to 4, wherein said resilient pad is made from a molded composite material.

6. A deflector according to any one of claims 1 to 5, wherein the lower part of the resilient pad has a shape generally matching that of the interior profile of at least one of said tracks.

7. A deflector according to claim 1, wherein at least part of said rigid plate is shaped as an arc following the sprocket or idler diameter.

8. A deflector according to claim 1 or 7, wherein said rigid plate is designed to avoid any interference with the inside of the track and is positioned with a space of around 0.5 inch to 1.5 inch from the sprocket or idler.

9. A deflector according to claim 1, 7 or 8, wherein said lower edge of the rigid plate has a shape generally similar to that of the lower part of the resilient pad.

10. A deflector according to claim 1, wherein said conjunction of the resilient pad with the rigid plate is made in a manner to define a hinge-like point to allow the resilient pad to be solid in the direction of ingestion, but pivotable in the other direction during the movement of the tracks.

11. A deflector that reduces the amount of snow, ice, gravel, soil and other debris ingestion in the sprocket area or idler area of a vehicle equipped with rubber tracks, said deflector comprising:
a) a rigid plate attached to said vehicle and positioned into close proximity of the outer perimeter of said sprocket or idler, said plate having a lower edge;
b) a resilient pad having an upper portion and a lower portion;
c) means to pivotally attach the upper portion of said pad to said plate.
